(19) United States
(12) Patent Application Publication
(10) Pub. No.: US 2023/0325475 A1
(43) Pub. Date: Oct. 12, 2023

(54) INFORMATION PROCESSING APPARATUS, INFORMATION PROCESSING METHOD, AND PROGRAM

(71) Applicant: NEC Corporation, Tokyo (JP)

(72) Inventors: Kiri INAYOSHI, Tokyo (JP); Takashi Nonaka, Tokyo (JP); Kentaro Nishida, Tokyo (JP)

(73) Assignee: NEC Corporation, Tokyo (JP)

(21) Appl. No.: 18/131,089

(22) Filed: Apr. 5, 2023

(30) Foreign Application Priority Data
Apr. 12, 2022 (JP) 2022-065805

(51) Int. Cl. G06F 21/10; G06T 11/00

(52) U.S. Cl. CPC G06F 21/105; G06T 11/00; G06F 2221/0724

(57) ABSTRACT

An information processing apparatus (1) includes at least one processor (C1) which carries out: a first acquisition process of acquiring information indicative of first data which is virtual space data and information indicative of a user of the first data; a retrieval process of retrieving second data which is virtual space data identical with or similar to the first data; a second acquisition process of acquiring information indicative of a purchaser of the second data; and a determination process of determining whether or not the purchaser of the second data is associated with the user of the first data.

### CROSS REFERENCE TO RELATED APPLICATIONS

This application is based upon and claims the benefit of priority from Japanese Patent Application No. 2022-065805 filed on Apr. 12, 2022, the disclosure of which is incorporated herein in its entirety by reference.

### TECHNICAL FIELD

The present invention relates to an information processing apparatus, an information processing method, and a program.

### BACKGROUND ART

A technique has been disclosed which is related to an avatar that is displayed instead of a user in a service on a virtual space.

Patent Literature 1 discloses an avatar provision system in which information of various services, sites, and the like on a network and avatars or items related to avatars are provided to a terminal apparatus.

### CITATION LIST

### Patent Literature

[Patent Literature 1]
Japanese Patent Application Publication Tokukai No. 2011-232846

### SUMMARY OF INVENTION

### Technical Problem

In recent years, an increasing number of users each use an avatar created by a creator or use the avatar with some modifications. There is an increasing number of cases in which a user makes unauthorized use, e.g., a user modifies such an avatar without permission of a creator who has created the avatar, a user acquires the avatar without authorization, and the like. However, such cases are not assumed in the technique disclosed in Patent Literature 1 above, and there is a problem that such unauthorized use cannot be prevented.

An example aspect of the present invention is accomplished in view of the above problem, and its example object is to provide a technique for preventing unauthorized use of data related to a service on a virtual space.

### Solution to Problem

An information processing apparatus according to an example aspect of the present invention includes at least one processor, the at least one processor carrying out: a first acquisition process of acquiring information indicative of first data and information indicative of a user of the first data, the first data being virtual space data that is related to a service on a virtual space; a retrieval process of retrieving second data which is virtual space data identical with or similar to the first data; a second acquisition process of acquiring information indicative of a purchaser of the second data; and a determination process of determining whether or not the purchaser of the second data is associated with the user of the first data.

An information processing method according to an example aspect of the present invention includes: acquiring, by at least one processor, information indicative of first data and information indicative of a user of the first data, the first data being virtual space data that is related to a service on a virtual space; retrieving, by the at least one processor, second data which is virtual space data identical with or similar to the first data; acquiring, by the at least one processor, information indicative of a purchaser of the second data; and determining, by the at least one processor, whether or not the purchaser of the second data is associated with the user of the first data.

A computer-readable non-transitory storage medium according to an example aspect of the present invention stores a program for causing a computer to function as an information processing apparatus, the program causing the computer to carry out: a first acquisition process of acquiring information indicative of first data and information indicative of a user of the first data, the first data being virtual space data that is related to a service on a virtual space; a retrieval process of retrieving second data which is virtual space data identical with or similar to the first data; a second acquisition process of acquiring information indicative of a purchaser of the second data; and a determination process of determining whether or not the purchaser of the second data is associated with the user of the first data.

### Advantageous Effects of Invention

According to an example aspect of the present invention, it is possible to prevent unauthorized use of data related to a service on a virtual space.

### BRIEF DESCRIPTION OF DRAWINGS

FIG. 1 is a block diagram illustrating a configuration of an information processing apparatus according to a first example embodiment of the present invention.

FIG. 2 is a flowchart illustrating a flow of an information processing method according to a first example embodiment of the present invention.

FIG. 3 is a block diagram illustrating a configuration of an information processing system according to a second example embodiment of the present invention.

FIG. 4 is a diagram illustrating an example of an image that is provided in the information processing system according to the second example embodiment of the present invention.

FIG. 5 is a diagram illustrating a flow of information in the information processing system according to the second example embodiment of the present invention.

FIG. 6 is a flowchart illustrating a flow of a process in the information processing system according to the second example embodiment of the present invention.

FIG. 7 is a diagram illustrating an example of an image that is provided by a service provision unit according to the second example embodiment of the present invention in accordance with a determination result.

FIG. 8 is a block diagram illustrating a configuration of an information processing system according to a third example embodiment of the present invention.

FIG. 9 is a block diagram illustrating an example of a hardware configuration of an information processing apparatus according to each example embodiment of the present invention and a terminal apparatus.

### EXAMPLE EMBODIMENTS

### First Example Embodiment

The following description will discuss a first example embodiment of the present invention in detail with reference to the drawings. The present example embodiment is a basic form of example embodiments described later.

(Overview of Information Processing Apparatus 1)

An information processing apparatus 1 according to the present example embodiment is an apparatus that determines whether or not a user of first data, which is virtual space data related to a service on a virtual space, is associated with a purchaser of second data, which is virtual space data identical with or similar to the first data.

The service on the virtual space is a service in which a virtual space constructed on a network is provided to users, and users can move in the virtual space and a plurality of users can communicate with each other. An example of the service on the virtual space is a virtual reality social networking service (VR-SNS).

The virtual space data is data used in a service on a virtual space. Examples of the virtual space data include data that is to be uploaded to a service on a virtual space and data that has been uploaded to the service. Here, the virtual space data can be purchased or can be available for free.

A specific example of the virtual space data is data indicating an avatar that represents a user in the virtual space. Another example of the virtual space data is data indicating an action to be performed by the avatar. That is, the virtual space data includes data indicating an avatar as a still image and a moving image; data and a program indicating an avatar as a three dimensional model; and data indicating a motion of an avatar.

Another example of the virtual space data is a program that describes a space in the virtual space (such as an environment, a venue, and a room in the virtual space), objects such as furniture, and interactions between the objects.

An example of a case in which the user of the first data is associated with the purchaser of the second data is a case in which the user of the first data is identical with the purchaser of the second data. Another example of a case in which the user of the first data is associated with the purchaser of the second data is a case in which the user of the first data is identical with a person to whom the second data has been transferred from the purchaser of the second data.

(Configuration of Information Processing Apparatus 1)

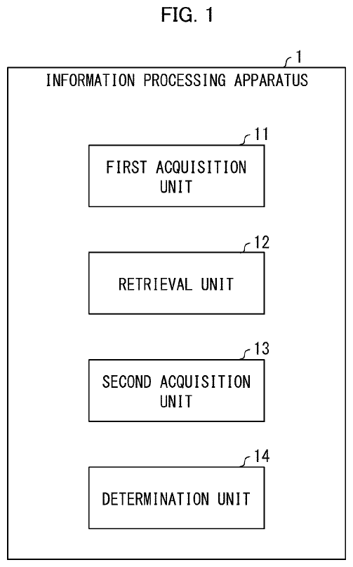

The following description will discuss a configuration of an information processing apparatus 1 according to the present example embodiment with reference to FIG. 1. FIG. 1 is a block diagram illustrating a configuration of the information processing apparatus 1 according to the present example embodiment.

The information processing apparatus 1 includes a first acquisition unit 11, a retrieval unit 12, a second acquisition unit 13, and a determination unit 14, as illustrate in FIG. 1. The first acquisition unit 11, the retrieval unit 12, the second acquisition unit 13, and the determination unit 14 are configured to realize the first acquisition section, the retrieval section, the second acquisition section, and the determination section, respectively, in the present example embodiment.

The first acquisition unit 11 acquires information indicative of first data which is virtual space data related to a service on a virtual space, and information indicative of a user of the first data. Examples of the information indicative of the first data include the first data itself, an identifier given to the first data, and the like. Hereinafter, unless otherwise stated, “first data” can be “first data itself” or can be “information indicative of first data”.

The first acquisition unit 11 can be configured to acquire a plurality of pieces of first data. For example, the first acquisition unit 11 can be configured to acquire information indicative of an avatar and information indicative of clothes of the avatar. As another example, the first acquisition unit 11 can be configured to acquire information indicative of a space of a room, information indicative of a first piece of furniture included in the room, and information indicative of a second piece of furniture included in the room.

The first acquisition unit 11 supplies the acquired information indicative of the first data to the retrieval unit 12. The first acquisition unit 11 supplies, to the determination unit 14, the acquired information indicative of the user of the first data.

The retrieval unit 12 retrieves second data which is virtual space data identical with or similar to the first data. The retrieval unit 12 supplies the identified second data to the second acquisition unit 13.

Here, in a case where the information indicative of the first data is an identifier given to the first data, the retrieval unit 12, for example, identifies the first data based on the identifier and retrieves second data which is virtual space data identical with or similar to the first data.

In a case where the first acquisition unit 11 has acquired a plurality of pieces of first data, the retrieval unit 12 can be configured to retrieve, for each of the plurality of pieces of first data, second data which is virtual space data identical with or similar to the first data.

For example, in a case where the first acquisition unit 11 has acquired information indicative of an avatar and information indicative of clothes of the avatar, the retrieval unit 12 retrieves, while regarding the information indicative of the avatar as first data, second data which is virtual space data identical with or similar to the first data. The retrieval unit 12 can be configured to retrieve, while regarding the information indicative of the clothes of the avatar as first data, second data which is virtual space data identical with or similar to the first data.

An example of a method in which the retrieval unit 12 retrieves second data similar to the first data is a configuration in which a similarity determination model is used which determines a degree of similarity between two pieces of data while using the two pieces of data as input. In this configuration, for example, the retrieval unit 12 inputs first data indicated by information supplied from the first acquisition unit 11 and a candidate for second data into the similarity determination model. Then, in a case where the degree of similarity is higher than a predetermined value, the retrieval unit 12 identifies the candidate as second data that is similar to the first data.

Here, a specific configuration of the similarity determination model is not limited and can be, for example, a convolution neural network (CNN), a recurrent neural network (RNN), or a combination of these networks. Alternatively, a non-neural network type model such as a random forest or a support vector machine can be used.

Another example of the method in which the retrieval unit 12 retrieves second data similar to the first data is a configuration in which data that is different from the first data in terms of at least any of a color, a texture, and a partial shape in a virtual space is identified to be second data. In other words, second data which is retrieved by the retrieval unit 12 can include data that is different from the first data in terms of at least any of a color, a texture, and a partial shape in the virtual space.

The second acquisition unit 13 acquires information indicative of a purchaser of second data. For example, the second acquisition unit 13 acquires information indicative of a purchaser of second data with reference to the second data supplied from the retrieval unit 12. The second acquisition unit 13 supplies the information indicative of the purchaser of the second data to the determination unit 14.

The determination unit 14 determines whether or not the purchaser of the second data is associated with the user of the first data. For example, the determination unit 14 determines whether or not the purchaser of the second data is associated with the user of the first data with reference to the information indicative of the purchaser of the second data which has been supplied from the second acquisition unit 13 and the information indicative of the user of the first data which has been supplied from the first acquisition unit 11.

As described above, the information processing apparatus 1 according to the present example embodiment employs the configuration of including: the first acquisition unit 11 that acquires information indicative of first data and information indicative of a user of the first data, the first data being virtual space data that is related to a service on a virtual space; the retrieval unit 12 that retrieves second data which is virtual space data identical with or similar to the first data; the second acquisition unit 13 that acquires information indicative of a purchaser of the second data; and the determination unit 14 that determines whether or not the purchaser of the second data is associated with the user of the first data.

That is, in a case where the user of the first data is not associated with the purchaser of the second data which is data identical with or similar to the first data, the information processing apparatus 1 according to the present example embodiment can prevent the user of the first data from using the first data. For example, in a case where the user of the first data is different from the purchaser of the second data, the information processing apparatus 1 according to the present example embodiment can prevent the user of the first data from using the first data. Therefore, according to the information processing apparatus 1 according to the present example embodiment, it is possible to bring about an effect of preventing unauthorized use of data related to a service on a virtual space.

(Flow of Information Processing Method S1)

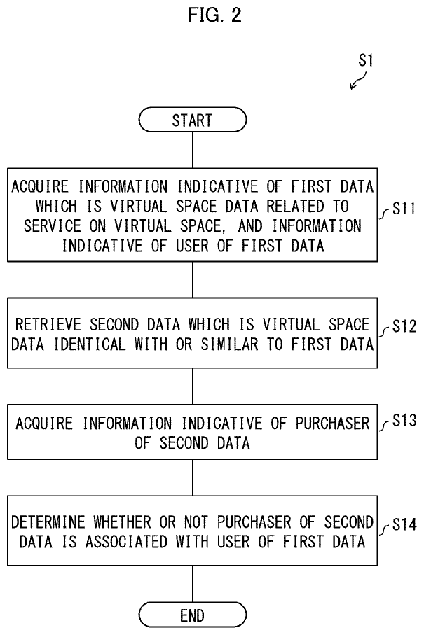

The following description will discuss a flow of an information processing method S1 according to the present example embodiment with reference to FIG. 2. FIG. 2 is a flowchart illustrating a flow of the information processing method S1 according to the present example embodiment.

(Step S11)

In step S11, the first acquisition unit 11 acquires information indicative of first data which is virtual space data related to a service on a virtual space, and information indicative of a user of the first data. The first acquisition unit 11 supplies the information indicative of the first data to the retrieval unit 12. The first acquisition unit 11 supplies, to the determination unit 14, the information indicative of the user of the first data.

(Step S12)

In step S12, the retrieval unit 12 retrieves second data which is virtual space data identical with or similar to the first data. The retrieval unit 12 supplies the second data to the second acquisition unit 13.

(Step S13)

In step S13, the second acquisition unit 13 acquires information indicative of a purchaser of the second data. The second acquisition unit 13 supplies the information indicative of the purchaser of the second data to the determination unit 14.

(Step S14)

In step S14, the determination unit 14 determines whether or not the purchaser of the second data is associated with the user of the first data.

As described above, in the information processing method S1 according to the present example embodiment, the first acquisition unit 11 acquires information indicative of first data and information indicative of a user of the first data in step S11, the retrieval unit 12 retrieves second data which is virtual space data identical with or similar to the first data in step S12, the second acquisition unit 13 acquires information indicative of a purchaser of the second data in step S13, and the determination unit 14 determines whether or not the purchaser of the second data is associated with the user of the first data in step S14. Therefore, according to the information processing method S1 according to the present example embodiment, an effect similar to that of the foregoing information processing apparatus 1 is brought about.

### Second Example Embodiment

The following description will discuss a second example embodiment of the present invention in detail with reference to the drawings. The same reference numerals are given to constituent elements which have functions identical with those described in the first example embodiment, and descriptions as to such constituent elements are omitted as appropriate.

(Overview of Information Processing System 100A)

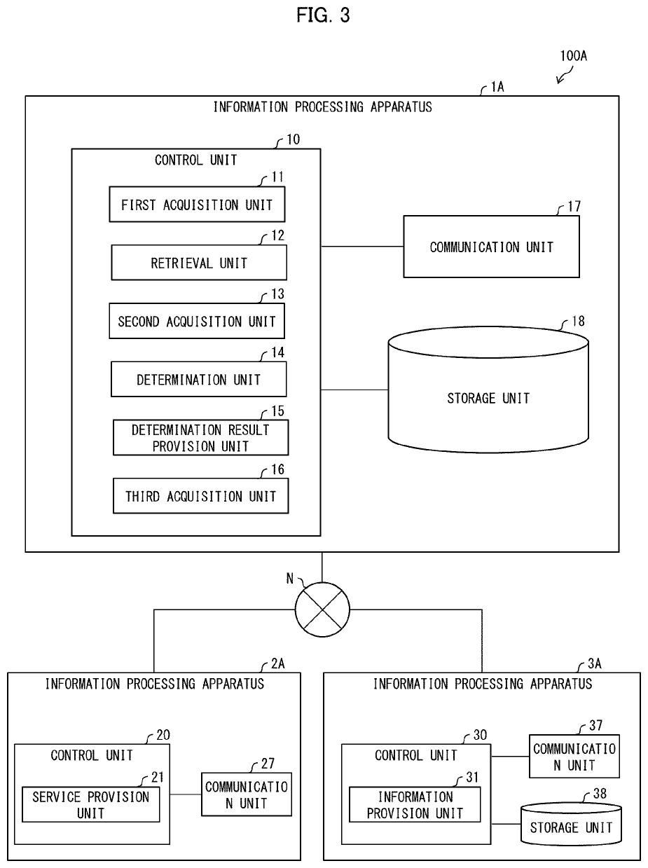

The following description will discuss an overview of an information processing system 100A according to the present example embodiment with reference to FIG. 3. FIG. 3 is a block diagram illustrating a configuration of an information processing system 100A according to the present example embodiment.

The information processing system 100A according to the present example embodiment is configured to include an information processing apparatus 1A, an information processing apparatus 2A, and an information processing apparatus 3A, as illustrated in FIG. 3. The information processing apparatus 1A and the information processing apparatus 2A are configured to realize the first information processing apparatus and the second information processing apparatus, respectively, in the present example embodiment.

The information processing apparatus 1A, the information processing apparatus 2A, and the information processing apparatus 3A are communicably connected with each other via a network N, as illustrated in FIG. 3. A specific configuration of the network N does not limited the present example embodiment but, as an example, it is possible to employ a wireless local area network (LAN), a wired LAN, a wide area network (WAN), a public network, a mobile data communication network, or a combination of these networks.

In the information processing system 100A, the information processing apparatus 3A sells second data which is virtual space data related to a service on a virtual space, and the information processing apparatus 2A provides the service on the virtual space. The information processing apparatus 1A determines whether or not a purchaser of the second data sold by the information processing apparatus 3A is associated with a user of first data which is virtual space data used in the service on the virtual space provided by the information processing apparatus 2A. An example of a flow of information and a flow of a process in the information processing system 100A will be described later.

The service on the virtual space, the virtual space data, and the case in which the user of the first data is associated with the purchaser of the second data are as described above.

(Configuration of Information Processing Apparatus 1A)

The information processing apparatus 1A includes a control unit 10, a communication unit 17, and a storage unit 18, as illustrate in FIG. 3.

The communication unit 17 is a communication module that communicates with other apparatuses that are connected thereto via the network N. For example, the communication unit 17 outputs data which has been supplied from the control unit 10 to another apparatus, and supplies data which has been output from another apparatus to the control unit 10.

The storage unit 18 stores data which the control unit refers to. For example, the storage unit 18 stores pieces of information indicative of a plurality of pieces of second data. In each of the pieces of information indicative of the plurality of pieces of second data, information indicative of a purchaser of that second data, identification information indicative of a preparer of that second data, and license information are included in association with each other.

Here, the identification information is information for confirming identification. The identification information can be any of an individual and a corporation, as long as identification can be confirmed.

Here, the license information is information that is generated by a preparer of second data and that restricts a utilization range of the second data. Examples of the information included in the license information include information indicative of a range in which second data can be distributed, and information indicative of a range in which second data can be modified.

Other examples of the license information include, as information that restricts the utilization range of the second data, information that restricts a method of uploading, information that restricts a subject (user) (e.g., only an individual, only a corporation, or the like), information that restricts a purpose of use (e.g., only for commercial purpose, only for non-commercial purpose, or the like), and information that restricts content of expression. An example of the license information is a virtual native 3D-model (VN3) license.

Examples of the range in which the second data can be distributed include a range in which the second data can be distributed only to pre-registered users, and a range in which the second data can be distributed only to users belonging to a predetermined organization.

Examples of the range in which the second data can be modified include a range in which only a color of the second data can be modified, a range in which only a texture of the second data can be modified, and a range in which only a partial shape of the second data can be modified.

A process example in the case in which the license information is referred to in the information processing system 100A will be described later.

(Function of Control Unit 10)

The control unit 10 controls constituent elements included in the information processing apparatus 1A. The control unit 10 functions also as a first acquisition unit 11, a retrieval unit 12, a second acquisition unit 13, a determination unit 14, a determination result provision unit 15, and a third acquisition unit 16, as illustrated in FIG. 3. The first acquisition unit 11, the retrieval unit 12, the second acquisition unit 13, the determination unit 14, the determination result provision unit 15, and the third acquisition unit 16 are configured to realize the first acquisition section, the retrieval section, the second acquisition section, the determination section, the determination result provision section, and the third acquisition section, respectively, in the present example embodiment.

The first acquisition unit 11 acquires information indicative of first data which is virtual space data related to a service on a virtual space, and information indicative of a user of the first data. The first acquisition unit 11 supplies the acquired information indicative of the first data to the retrieval unit 12. The first acquisition unit 11 supplies, to the determination unit 14, the acquired information indicative of the user of the first data.

The retrieval unit 12 retrieves second data which is virtual space data identical with or similar to the first data. For example, the retrieval unit 12 refers to information indicative of first data supplied from the first acquisition unit 11 and retrieves second data which is virtual space data identical with or similar to the first data from pieces of information indicative of a plurality of pieces of second data that are stored in the storage unit 18. The retrieval unit 12 supplies the identified second data to the second acquisition unit 13.

An example of a method in which the retrieval unit 12 retrieves the second data is a configuration in which a similarity determination model is used, as described above.

As described above, second data which is retrieved by the retrieval unit 12 can include data that is different from the first data in terms of at least any of a color, a texture, and a partial shape in the virtual space.

Thus, the retrieval unit 12 retrieves, as second data, data that is different from the first data in terms of at least any of a color, a texture, and a partial shape in the virtual space. Therefore, it is possible to prevent unauthorized use of the first data even in a case where a color, a texture, and a partial shape of the first data have been modified after the first data had been purchased.

The retrieval unit 12 can retrieve second data with reference to information included in the license information. The configuration in which the retrieval unit 12 refers to the information included in the license information will be described later.

The second acquisition unit 13 acquires information indicative of a purchaser of the second data. For example, the second acquisition unit 13 acquires, from the storage unit 18, information that is associated with information indicated by second data and that is indicative of a purchaser of the second data, with reference to the second data which has been supplied from the retrieval unit 12. The second acquisition unit 13 supplies the information indicative of the purchaser of the second data to the determination unit 14.

In a case where the second data is transferred from the purchaser to another person, the second acquisition unit 13 acquires information indicative of that another person. Then, the second acquisition unit 13 causes the storage unit 18 to store the information indicative of that another person.

The determination unit 14 determines whether or not the purchaser of the second data is associated with the user of the first data. For example, the determination unit 14 determines whether or not the purchaser of the second data is associated with the user of the first data with reference to the information indicative of the purchaser of the second data which has been supplied from the second acquisition unit 13 and the information indicative of the user of the first data which has been supplied from the first acquisition unit 11.

The determination unit 14 can determine whether or not the purchaser of the second data is associated with the user of the first data with reference to the license information. The configuration in which the determination unit 14 refers to information included in the license information will be described later. The determination unit 14 supplies the determination result to the determination result provision unit 15.

The determination result provision unit 15 provides the determination result by the determination unit 14 to the information processing apparatus 2A via the communication unit 17. Thus, the determination result provision unit 15 provides the determination result to the information processing apparatus 2A. Therefore, in a case where the determination result is negative, it is possible to cause the information processing apparatus 2A to terminate provision of the service.

The third acquisition unit 16 acquires, from the preparer of the second data, identification information indicative of the preparer and license information for the second data. The third acquisition unit 16 causes the storage unit 18 to store the identification information and license information which have been acquired.

(Configuration of Information Processing Apparatus 2A)

The information processing apparatus 2A includes a control unit 20 and a communication unit 27, as illustrated in FIG. 3.

The communication unit 27 is a communication module that communicates with other apparatuses that are connected thereto via the network N. For example, the communication unit 27 outputs data which has been supplied from the control unit 20 to another apparatus, and supplies data which has been output from another apparatus to the control unit 20.

The control unit 20 controls constituent elements included in the information processing apparatus 2A. The control unit 20 functions also as a service provision unit 21, as illustrated in FIG. 3. The service provision unit 21 is configured to realize the service provision section in the present example embodiment.

The service provision unit 21 provides a service on a virtual space. For example, the service provision unit 21 receives uploading of first data.

The service provision unit 21 can acquire the determination result provided from the information processing apparatus 1A via the communication unit 27. In this case, the service provision unit 21 can permit uploading of the first data with respect to the service in a case where the determination result is positive.

Thus, in a case where the determination result is positive, the service provision unit 21 permits uploading of the first data with respect to the service. This makes it possible to prevent unauthorized use of the first data.

(Example of Image of Service Provided by Service Provision Unit 21)

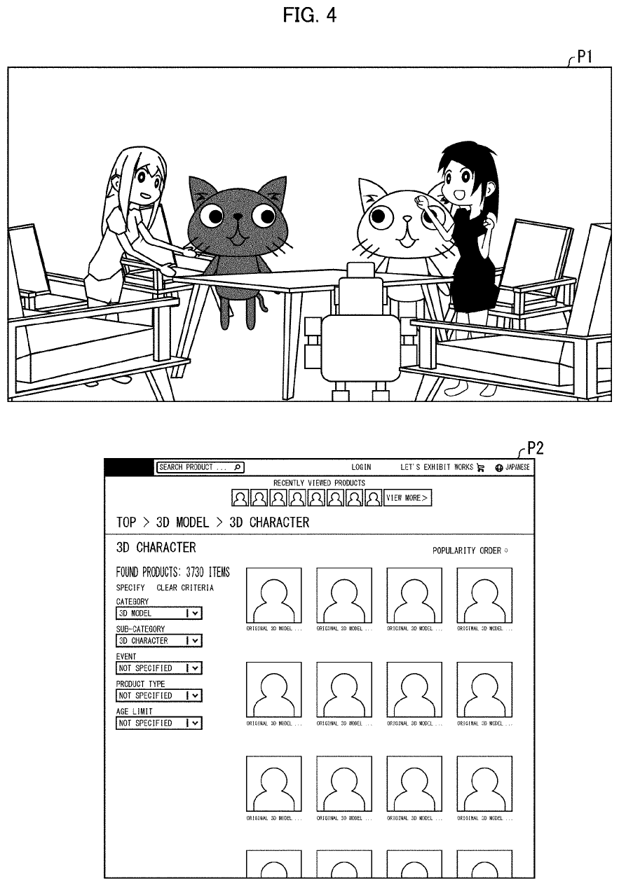

The following description will discuss an example of an image of a service provided by the service provision unit 21, with reference to FIG. 4. FIG. 4 is a diagram illustrating an example of an image that is provided in the information processing system 100A according to the present example embodiment.

For example, the service provision unit 21 provides an image P1 including avatars that represent a respective plurality of users in a virtual space, as illustrated in the upper part of FIG. 4. The avatar included in the image P1 can be an avatar which has been uploaded by the user and received by the service provision unit 21. The service provision unit 21 carries out processes of moving the avatars and causing the avatars to speak in response to input from the plurality of users of the respective avatars included in the image P1.

(Configuration of Information Processing Apparatus 3A)

The information processing apparatus 3A includes a control unit 30, a communication unit 37, and a storage unit 38, as illustrate in FIG. 3.

The communication unit 37 is a communication module that communicates with other apparatuses that are connected thereto via the network N. For example, the communication unit 37 outputs data which has been supplied from the control unit 30 to another apparatus, and supplies data which has been output from another apparatus to the control unit 30.

The storage unit 38 stores data which the control unit refers to. For example, the storage unit 38 stores pieces of information indicative of a plurality of pieces of second data. In each of the pieces of information indicative of the plurality of pieces of second data, identification information indicative of a preparer of that second data, and license information are included while being associated with each other.

The control unit 30 controls constituent elements included in the information processing apparatus 3A. The control unit 30 functions also as an information provision unit 31, as illustrated in FIG. 3.

In a case where second data is purchased, the information provision unit 31 outputs identification information indicative of a purchaser of the second data to the information processing apparatus 1A via the communication unit 37. In a case where the second data is transferred from the purchaser to another person, the information provision unit 31 outputs information indicative of that another person to the information processing apparatus 1A via the communication unit 37.

(Example of Image Provided by Information Processing Apparatus 3A)

The following description will discuss an example of an image that is provided by the information processing apparatus 3A, with reference to FIG. 4.

The information processing apparatus 3A provides, for example, an image P2 including a plurality of avatars which are each second data, as illustrated in the lower part of FIG. 4. The information processing apparatus 3A provides an avatar which has been selected by a purchaser to the purchaser. In a case where a purchaser purchases an avatar, the information processing apparatus 3A acquires identification information as information indicative of the purchaser.

(Flow of Information in Information Processing System 100A)

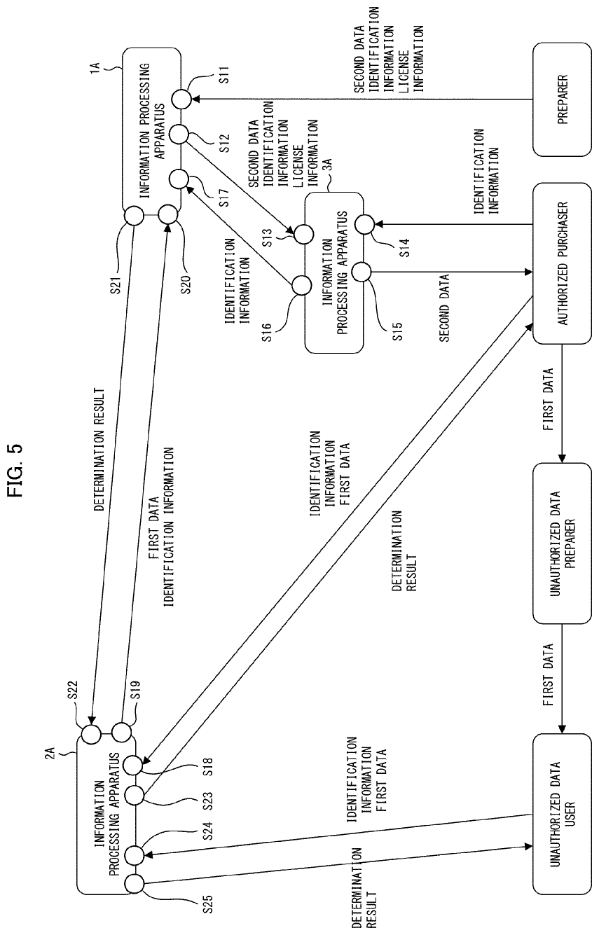

The following description will discuss a flow of information in the information processing system 100A with reference to FIG. 5. FIG. 5 is a diagram illustrating a flow of information in the information processing system 100A according to the present example embodiment. FIG. 5 describes a flow of information that is output and acquired by apparatuses. A process that is carried out by each apparatus will be described later.

(Step S11)

In step S11, the control unit 10 of the information processing apparatus 1A acquires second data from a terminal of a preparer. The third acquisition unit 16 of the information processing apparatus 1A acquires, from the terminal of the preparer, identification information indicative of the preparer of the second data and license information.

(Step S12)

In step S12, the control unit 10 of the information processing apparatus 1A outputs the second data which has been acquired in step S11, and the identification information and the license information which have been acquired by the third acquisition unit 16 to the information processing apparatus 3A.

(Step S13)

In step S13, the control unit 30 of the information processing apparatus 3A acquires the second data, the identification information, and the license information which have been output from the information processing apparatus 1A in step S12.

Here, the above described step S11 can be carried out by the control unit 30 of the information processing apparatus 3A. In this case, in step S11, the control unit 30 of the information processing apparatus 3A acquires the second data, the identification information, and the license information. Next, in step S12, the control unit 30 of the information processing apparatus 3A outputs the second data, the identification information, and the license information which have been acquired to the information processing apparatus 1A. Then, in step S13, the control unit 10 of the information processing apparatus 1A acquires the second data, and the third acquisition unit 16 acquires the identification information and the license information.

The above described step S11 can be carried out by the control unit 20 of the information processing apparatus 2A. In this case, in step S11, the control unit 20 of the information processing apparatus 2A acquires the second data, the identification information, and the license information. Next, in step S12, the control unit 20 of the information processing apparatus 2A outputs the second data, the identification information, and the license information which have been acquired to the information processing apparatus 1A and the information processing apparatus 3A. Then, in step S13, the control unit 10 of the information processing apparatus 1A acquires the second data, and the third acquisition unit 16 acquires the identification information and the license information. Moreover, the control unit 20 of the information processing apparatus 2A acquires the second data, the identification information, and the license information.

(Step S14)

In step S14, the control unit 30 of the information processing apparatus 3A acquires identification information indicative of an authorized purchaser from a terminal of the authorized purchaser who purchases the second data.

(Step S15)

In step S15, the control unit 30 of the information processing apparatus 3A outputs the second data to the terminal of the authorized purchaser. That is, the information processing apparatus 3A sells the second data by carrying out the processes of steps S14 and S15.

(Step S16)

In step S16, the control unit 30 of the information processing apparatus 3A outputs the identification information acquired in step S14 to the information processing apparatus 1A.

(Step S17)

In step S17, the control unit 10 of the information processing apparatus 1A acquires the identification information.

Here, in a case where the purchased second data is transferred from the purchaser to another person, the control unit 30 of the information processing apparatus 3A acquires, in a manner similar to step S14, identification information indicative of that another person to whom the second data is transferred. Then, in a manner similar to step S16, the control unit 30 of the information processing apparatus 3A outputs, to the information processing apparatus 1A, the identification information indicative of that another person. The control unit 10 of the information processing apparatus 1A acquires the identification information indicative of that another person in a manner similar to step S17.

(Step S18)

In step S18, the service provision unit 21 of the information processing apparatus 2A acquires, from the terminal of the authorized purchaser, the first data and the identification information indicative of the user, and thus receives uploading of the first data.

(Step S19)

In step S19, the service provision unit 21 of the information processing apparatus 2A outputs the first data and the identification information to the information processing apparatus 1A.

(Step S20)

In step S20, the first acquisition unit 11 of the information processing apparatus 1A acquires the first data and the identification information which have been output from the information processing apparatus 2A in step S19.

(Step S21)

In step S21, the determination result provision unit 15 of the information processing apparatus 1A outputs the determination result by the determination unit 14 to the information processing apparatus 2A. Here, the first data acquired by the first acquisition unit 11 in step S20 is data from the authorized purchaser. Therefore, the determination result by the determination unit 14 is a positive determination result.

(Step S22)

In step S22, the service provision unit 21 of the information processing apparatus 2A acquires the determination result which has been output from the information processing apparatus 1A in step S21.

(Step S23)

In step S23, the service provision unit 21 of the information processing apparatus 2A outputs the positive determination result acquired in step S22 to the terminal of the authorized purchaser.

(Step S24)

Meanwhile, in a case where an unauthorized data preparer acquires first data without authorization from an authorized purchaser and prepares first data without authorization, and an unauthorized data user acquires the first data prepared without authorization from the unauthorized data preparer and uses the first data, the service provision unit 21 of the information processing apparatus 2A acquires the first data and identification information indicative of the user from a terminal of the unauthorized data user, and thus receives uploading of the first data in step S24.

(Steps S19 through S22)

In a manner similar to step S19 above, the information processing apparatus 2A outputs the first data and the identification information which have been acquired in step S24 to the information processing apparatus 1A.

The first acquisition unit 11 of the information processing apparatus 1A acquires the first data and the identification information in a manner similar to step S20 above, and the determination result provision unit 15 outputs the determination result to the information processing apparatus 2A in a manner similar to step S21. Here, the first data acquired by the first acquisition unit 11 in step S20 is data acquired from the unauthorized data user. Therefore, the determination result by the determination unit 14 is a negative determination result. Then, the service provision unit 21 of the information processing apparatus 2A acquires the determination result in a manner similar to step S22 above.

(Step S25)

In step S25, the service provision unit 21 of the information processing apparatus 2A outputs the negative determination result acquired in step S22 to the terminal of the unauthorized data user.

(Flow of Process in Information Processing System 100A)

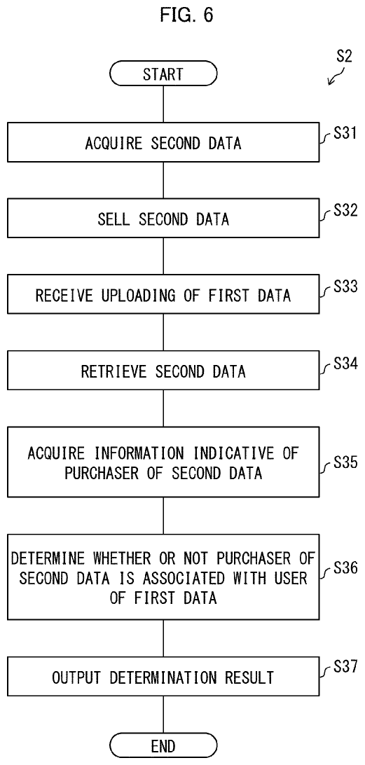

The following description will discuss a flow of a process in the information processing system 100A with reference to FIG. 6 using the steps in FIG. 5 described above. FIG. 6 is a flowchart illustrating a flow of a process in the information processing system 100A according to the present example embodiment.

(Step S31)

In step S31, the control unit 10 of the information processing apparatus 1A causes the storage unit 18 to store the second data which has been acquired in step S11 and the identification information indicative of the preparer of the second data and the license information which have been acquired by the third acquisition unit 16, in association with each other. Then, the control unit 10 outputs the second data, the identification information, and the license information to the information processing apparatus 3A (step S12).

The control unit 30 of the information processing apparatus 3A causes the storage unit 38 to store the second data, the identification information, and the license information which have been acquired in step S13 in association with each other.

(Step S32)

In step S32, the control unit 30 of the information processing apparatus 3A sells the second data (step S14 and step S15). Moreover, the control unit 30 outputs the identification information indicative of the user to the information processing apparatus 1A (step S16).

The control unit 10 of the information processing apparatus 1A causes the storage unit 18 to store the identification information acquired in step S17 in association with the second data.

(Step S33)

In step S33, the service provision unit 21 of the information processing apparatus 2A outputs the first data and the identification information indicative of the user which have been acquired in step S18 and step S24 to the information processing apparatus 1A (step S19).

The first acquisition unit 11 of the information processing apparatus 1A supplies the first data acquired in step S20 to the retrieval unit 12 and supplies the identification information to the determination unit 14.

Here, in step S33, the service provision unit 21 can be configured to output the first data and the identification information to the information processing apparatus 1A in response to uploading of the first data. In other words, the information indicative of the first data and the information indicative of the user of the first data which are acquired by the first acquisition unit 11 can be information provided from the information processing apparatus 2A in response to an attempt by the user to upload the first data with respect to the information processing apparatus 2A.

Thus, in the information processing system 100A, in response to an attempt to upload the first data, the information indicative of the first data and the information indicative of the user of the first data are provided to the information processing apparatus 1A. This makes it possible to prevent unauthorized use of the first data before the first data is used.

(Step S34)

In step S34, the retrieval unit 12 retrieves, from a plurality of pieces of second data stored in the storage unit 18, second data which is virtual space data identical with or similar to the first data which has been supplied from the first acquisition unit 11 in step S33. The retrieval unit 12 supplies the identified second data to the second acquisition unit 13.

(Step S35)

In step S35, the second acquisition unit 13 acquires, from the storage unit 18, the identification information which is indicative of a purchaser of the second data associated with the second data, with reference to the second data which has been output from the retrieval unit 12 in step S34. The second acquisition unit 13 supplies the acquired identification information to the determination unit 14.

(Step S36)

In step S36, the determination unit 14 determines whether or not the purchaser of the second data is associated with the user of the first data with reference to the identification information which has been supplied from the first acquisition unit 11 in step S33 and the identification information which has been supplied from the second acquisition unit 13 in step S35. The determination unit 14 supplies the determination result to the determination result provision unit 15.

(Step S37)

In step S37, the determination result provision unit 15 outputs the determination result supplied from the determination unit 14 in step S36 to the information processing apparatus 2A (step S21).

The service provision unit 21 of the information processing apparatus 2A outputs the determination result acquired in step S22 to the terminal of the user (step S23 or step S25).

(Process Example 1 in which License Information is Referred to)

The following description will discuss a process example in which license information is referred to.

For example, in a case where the license information includes information indicative of a range in which the second data can be distributed, the determination unit 14 determines, in step S36 above, whether or not the purchaser of the second data is associated with the user of the first data with reference to the license information.

For example, in a case where the license information indicates that second data can be distributed only to pre-registered users, the determination unit 14 determines whether or not a user indicated by identification information supplied from the second acquisition unit 13 is a pre-registered user. In a case where the user indicated by the identification information supplied from the second acquisition unit 13 is a pre-registered user, the determination unit 14 supplies a positive determination result to the determination result provision unit 15. Meanwhile, in a case where the user indicated by the identification information supplied from the second acquisition unit 13 is not a pre-registered user, the determination unit 14 supplies a negative determination result to the determination result provision unit 15.

Thus, the determination unit 14 determines whether or not the purchaser of the second data is associated with the user of the first data with reference to the license information. This makes it possible to prevent unauthorized use of the first data.

In a case where the license information includes information indicative of a range in which the second data can be distributed, the control unit 30 of the information processing apparatus 3A can sell the second data with reference to the license information in step S32 above.

For example, in a case where the license information indicates that the second data can be distributed only to pre-registered users, the control unit 30 of the information processing apparatus 3A acquires identification information indicative of a user from a terminal of the user. Next, upon receipt of purchase of the second data, the control unit 30 determines whether or not the user is a pre-registered user with reference to the acquired identification information. In a case where the user is a pre-registered user, the control unit 30 of the information processing apparatus 3A outputs the second data to the terminal of the user. Meanwhile, in the case where the user is a user who has not been pre-registered, the control unit 30 of the information processing apparatus 3A does not output the second data to the terminal of the user.

(Process Example 2 in which License Information is Referred to)

As another example, in a case where the license information includes information indicating a range in which second data can be modified, the retrieval unit 12 retrieves the second data with reference to the license information in step S34 above.

For example, in a case where license information indicates that only a color of second data can be modified, the retrieval unit 12 retrieves, from a plurality of pieces of second data stored in the storage unit 18, second data which is identical with first data and second data which is different from the first data only in color.

In a case where second data which is identical with the first data and second data which is different only in color from the first data are not identified, the retrieval unit 12 may retrieve second data which is identical in color with the first data and is different in at least any of a texture and a partial shape from the first data. In this case, in a case where the second data is identified by the retrieval unit 12, the first data is identified as data that exceeds the utilization range of the second data.

Thus, the retrieval unit 12 retrieves second data with reference to the license information. This makes it possible to prevent unauthorized use of the first data when the first data is not encompassed in the utilization range.

(Process Example 3 in which License Information is Referred to)

As a still another example, in a case where the license information includes, as information indicative of a range in which second data can be modified, information pertaining to an index indicating a degree of similarity between first data and second data, the retrieval unit 12 retrieves second data with reference to the index in step S34 above.

For example, in a case where the license information indicates that the index indicative of the degree of similarity between first data and second data is 50%, the retrieval unit 12 inputs first data and second data into the above described similarity determination model. Then, in a case where the degree of similarity output from the similarity determination model is higher than 50%, the retrieval unit 12 identifies the second data as data which is identical with or similar to the first data.

Thus, the retrieval unit 12 retrieves second data with reference to an index indicative of a degree of similarity between first data and second data. This makes it possible to appropriately identify second data which is identical with or similar to first data.

(Process Example 4 in which License Information is Referred to)

As yet another example, in a case where the license information includes information that restricts a subject (user), the service provision unit 21 of the information processing apparatus 2A may provide a service with reference to the license information.

For example, in step S22 above, the service provision unit 21 acquires the determination result and the license information associated with the first data from the information processing apparatus 1A. Then, in a case where the user of the first data is a user who is permitted to use the first data by the acquired license information, the service provision unit 21 provides an image indicating that the user of the first data is a user who is permitted to use the first data. For example, the service provision unit 21 provides an image with a mark indicating certification with respect to the first data which has been uploaded by the user of the first data.

(Process Example 5 in which License Information is Referred to)

As still another example, in a case where the license information includes information that restricts expression content of the second data, the service provision unit 21 of the information processing apparatus 2A may provide a service with reference to the license information.

For example, in step S22 above, the service provision unit 21 acquires the determination result and the license information associated with the first data from the information processing apparatus 1A. Then, in a case where a motion of the first data received from the user of the first data is not permitted by the license information, the service provision unit 21 provides an image indicating that the motion of the first data received from the user of the first data is not permitted. For example, the service provision unit 21 provides an image with a mark indicating that the received motion cannot be performed, with respect to the first data uploaded by the user of the first data.

(Example of Image Provided by Service Provision Unit 21 in Accordance with Determination Result)

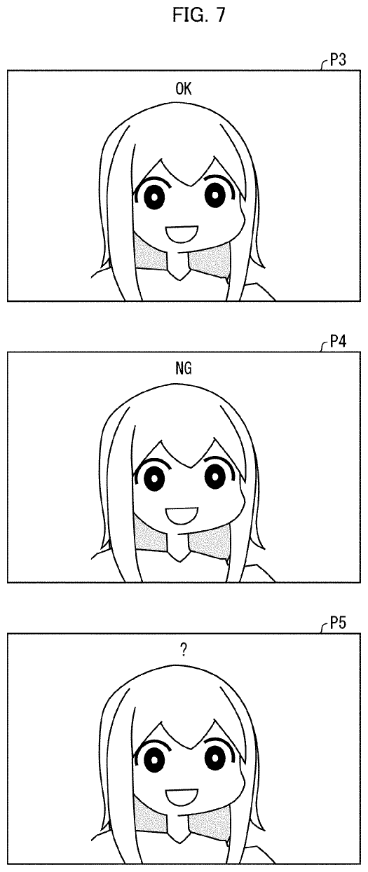

The following description will discuss an example of an image that is provided by the service provision unit 21 in accordance with a determination result, with reference to FIG. 7. FIG. 7 is a diagram illustrating an example of an image that is provided by the service provision unit 21 according to the present example embodiment in accordance with a determination result.

Upon acquisition of the above described determination result, the service provision unit 21 may change a display mode in accordance with the determination result. For example, the service provision unit 21 may cause a display mode of the first data in a case in which the determination result by the determination unit 14 is positive to be different from a display mode of the first data in a case in which the determination result by the determination unit 14 is negative or no determination result is obtained by the determination unit 14.

For example, in a case where the determination result by the determination unit 14 is positive, the service provision unit 21 provides an image P3 in which a character string “OK”, which indicates that the determination result is positive, is affixed to an avatar which is the first data, as illustrated in the upper part of FIG. 7.

Meanwhile, in a case where the determination result by the determination unit 14 is negative, the service provision unit 21 provides an image P4 in which a character string “NG”, which indicates that the determination result is negative, is affixed to the avatar which is the first data, as illustrated in the middle part of FIG. 7.

In a case where no determination result has been obtained by the determination unit 14, the service provision unit 21 provides an image P5 in which a symbol “?”, which indicates that no determination result has been obtained, is affixed to the avatar which is the first data, as illustrated in the lower part of FIG. 7.

Thus, the service provision unit 21 causes the display mode of the first data to be different between the case in which the determination result is positive and the case in which the determination result is negative or no determination result is obtained. Therefore, in the service provided, the service provision unit 21 can present to the user whether or not the first data is used without authorization.

(Effect of Information Processing System 100A)

As described above, in the information processing system 100A according to the present example embodiment, the information processing apparatus 2A provides a service on a virtual space, and the information processing apparatus 1A determines whether or not a purchaser of second data is associated with a user of first data. Therefore, in the information processing system 100A according to the present example embodiment, an effect similar to that of the information processing apparatus 1 described above is brought about.

### Third Example Embodiment

The following description will discuss a third example embodiment of the present invention in detail with reference to the drawings. The same reference numerals are given to constituent elements which have functions identical with those described in the foregoing example embodiments, and descriptions as to such constituent elements are not repeated.

(Overview of Information Processing System 100B)

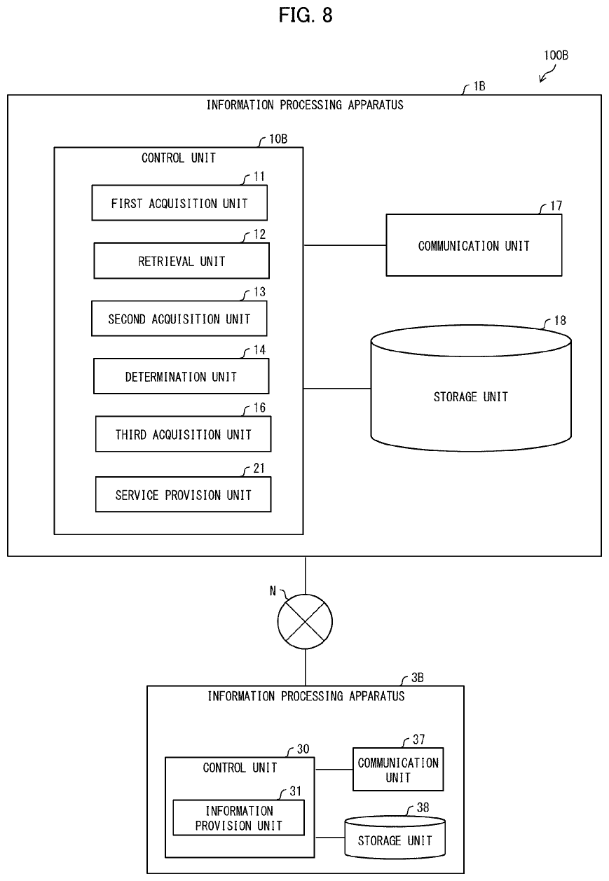

The following description will discuss an overview of an information processing system 100B according to the present example embodiment with reference to FIG. 8. FIG. 8 is a block diagram illustrating a configuration of an information processing system 100B according to the present example embodiment.

The information processing system 100B according to the present example embodiment is configured to include an information processing apparatus 1B and an information processing apparatus 3B, as illustrated in FIG. 8. The information processing apparatus 1B and the information processing apparatus 3B are communicably connected to each other via a network N, as illustrated in FIG. 8. A specific configuration of the network N is as described above.

In the information processing system 100B, the information processing apparatus 3B sells second data which is virtual space data related to a service on a virtual space, and the information processing apparatus 1B provides the service on the virtual space. The information processing apparatus 1B determines whether or not a purchaser of the second data sold by the information processing apparatus 3B is associated with a user of first data which is virtual space data used in the service on the virtual space provided by the information processing apparatus 1B.

Here, a configuration of the information processing apparatus 3B is identical with that of the above described information processing apparatus 3A, and is therefore not described here.

(Configuration of Information Processing Apparatus 1B)

The information processing apparatus 1B includes a control unit 10B, a communication unit 17, and a storage unit 18, as illustrate in FIG. 8. The communication unit 17 and the storage unit 18 are as described above.

The control unit 10B controls constituent elements included in the information processing apparatus 1B. The control unit 10B functions also as a first acquisition unit 11, a retrieval unit 12, a second acquisition unit 13, a determination unit 14, a third acquisition unit 16, and a service provision unit 21, as illustrated in FIG. 8. The first acquisition unit 11, the retrieval unit 12, the second acquisition unit 13, the determination unit 14, the third acquisition unit 16, and the service provision unit 21 are configured to realize the first acquisition section, the retrieval section, the second acquisition section, the determination section, the third acquisition section, and the service provision section, respectively, in the present example embodiment.

The retrieval unit 12, the second acquisition unit 13, and the third acquisition unit 16 are as described above.

The first acquisition unit 11 acquires, from the service provision unit 21, information indicative of first data which is virtual space data related to a service on a virtual space, and information indicative of a user of the first data. The first acquisition unit 11 supplies the acquired information indicative of the first data to the retrieval unit 12. The first acquisition unit 11 supplies, to the determination unit 14, the acquired information indicative of the user of the first data.

The determination unit 14 determines whether or not a purchaser of second data is associated with the user of the first data. An example of a process that is carried out by the determination unit 14 is as described above. The determination unit 14 supplies the determination result to the service provision unit 21. That is, the determination result by the determination unit 14 is provided to the service provision unit 21.

Thus, the determination result by the determination unit 14 is provided to the service provision unit 21. Therefore, in a case where a negative determination result is obtained, the service provision unit 21 can terminate provision of the service.

The service provision unit 21 provides a service on a virtual space. Moreover, the service provision unit 21 receives uploading of first data.

The service provision unit 21 can be configured to supply the first data and the identification information to the first acquisition unit 11 in response to uploading of the first data. In other words, the information indicative of the first data and the information indicative of the user of the first data which are acquired by the first acquisition unit 11 can be information provided from the service provision unit 21 in response to an attempt by the user to upload the first data with respect to the service provision unit 21.

Thus, the service provision unit 21 provides, in response to an attempt to upload the first data, the information indicative of the first data and the information indicative of the user of the first data to the first acquisition unit 11. This makes it possible to prevent unauthorized use of the first data before the first data is used.

The service provision unit 21 may acquire the determination result provided from the determination unit 14, and permit uploading of the first data with respect to the service in a case where the determination result by the determination unit 14 is positive.

Thus, in a case where the determination result is positive, the service provision unit 21 permits uploading of the first data with respect to the service. This makes it possible to prevent unauthorized use of the first data.

The service provision unit 21 may cause a display mode of the first data in a case in which the determination result by the determination unit 14 is positive to be different from a display mode of the first data in a case in which the determination result by the determination unit 14 is negative or no determination result is obtained by the determination unit 14. An example of an image that is provided by the service provision unit 21 in accordance with the determination result is as described above.

Thus, the service provision unit 21 causes the display mode of the first data to be different between the case in which the determination result is positive and the case in which the determination result is negative or no determination result is obtained. Therefore, in the service provided by the service provision unit 21, it is possible to present to the user whether or not the first data is used without authorization.

(Effect of Information Processing System 100B)

As described above, in the information processing system 100B according to the present example embodiment, the information processing apparatus 1B provides a service on a virtual space, and further determines whether or not a purchaser of second data is associated with a user of first data. Therefore, in the information processing system 100B according to the present example embodiment, an effect similar to that of the information processing apparatus 1 described above is brought about.

### Software Implementation Example

The functions of part of or all of the information processing apparatuses 1, 1A, 1B, 2A, 3A, and 3B can be realized by hardware such as an integrated circuit (IC chip) or can be alternatively realized by software.

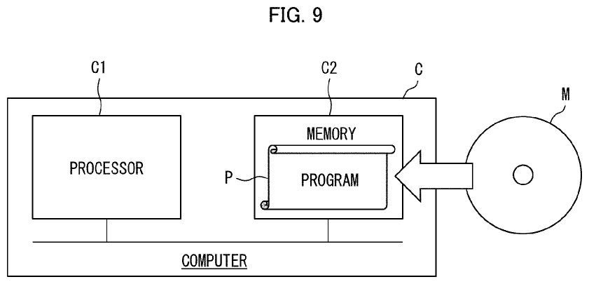

In the latter case, each of the information processing apparatuses 1, 1A, 1B, 2A, 3A, and 3B is realized by, for example, a computer that executes instructions of a program that is software realizing the foregoing functions. FIG. 9 illustrates an example of such a computer (hereinafter, referred to as “computer C”). The computer C includes at least one processor C1 and at least one memory C2. The memory C2 stores a program P for causing the computer C to function as the information processing apparatuses 1, 1A, 1B, 2A, 3A, and 3B. In the computer C, the processor C1 reads the program P from the memory C2 and executes the program P, so that the functions of the information processing apparatuses 1, 1A, 1B, 2A, 3A, and 3B are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

Some of or all of the foregoing example embodiments can also be described as below. Note, however, that the present invention is not limited to the following example aspects.

(Supplementary Note 1)

An information processing apparatus including: a first acquisition section that acquires information indicative of first data and information indicative of a user of the first data, the first data being virtual space data that is related to a service on a virtual space; a retrieval section that retrieves second data which is virtual space data identical with or similar to the first data; a second acquisition section that acquires information indicative of a purchaser of the second data; and a determination section that determines whether or not the purchaser of the second data is associated with the user of the first data.

(Supplementary Note 2)

An information processing apparatus according to supplementary note 1, in which: the second data which is retrieved by the retrieval section includes data that is different from the first data in terms of at least any of a color, a texture, and a partial shape in the virtual space.

(Supplementary Note 3)

The information processing apparatus according to supplementary note 1 or 2, further including: a third acquisition section that acquires, from a preparer of the second data, identification information indicative of the preparer and license information for the second data, the determination section determining whether or not the purchaser of the second data is associated with the user of the first data with reference to the license information.

(Supplementary Note 4)

The information processing apparatus according to supplementary note 3, in which: the retrieval section retrieves the second data with reference to the license information.

(Supplementary Note 5)

The information processing apparatus according to supplementary note 3 or 4, in which: the license information includes information pertaining to an index indicating a degree of similarity between the first data and the second data; and the retrieval section retrieves the second data with reference to the index.

(Supplementary Note 6)

The information processing apparatus according to any one of supplementary notes 1 through 5, further including: a service provision section that provides the service on the virtual space, the information indicative of the first data and the information indicative of the user of the first data which are acquired by the first acquisition section each being provided from the service provision section in response to an attempt by the user to upload the first data with respect to the service provision section.

(Supplementary Note 7)

The information processing apparatus according to supplementary note 6, in which: a determination result by the determination section is provided to the service provision section.

(Supplementary Note 8)

The information processing apparatus according to supplementary note 7, in which: in a case where the determination result by the determination section is positive, the service provision section permits uploading of the first data with respect to the service.

(Supplementary Note 9)

The information processing apparatus according to supplementary note 7, in which: the service provision section causes a display mode of the first data in a case in which the determination result by the determination section is positive to be different from a display mode of the first data in a case in which the determination result by the determination section is negative or no determination result is obtained by the determination section.

(Supplementary Note 10)

An information processing system including a first information processing apparatus and a second information processing apparatus that provides a service on a virtual space, the first information processing apparatus including: a first acquisition section that acquires information indicative of first data and information indicative of a user of the first data, the first data being virtual space data that is related to the service on the virtual space; a retrieval section that retrieves second data which is virtual space data identical with or similar to the first data; a second acquisition section that acquires information indicative of a purchaser of the second data; and a determination section that determines whether or not the purchaser of the second data is associated with the user of the first data.

(Supplementary Note 11)

The information processing system according to supplementary note 10, in which: the information indicative of the first data and the information indicative of the user of the first data which are acquired by the first acquisition section are each provided from the second information processing apparatus in response to an attempt by the user to upload the first data with respect to the second information processing apparatus.

(Supplementary Note 12)

The information processing system according to supplementary note 10, in which the first information processing apparatus further includes a determination result provision section that provides a determination result by the determination section to the second information processing apparatus.

(Supplementary Note 13)

The information processing system according to supplementary note 12, in which: in a case where the determination result by the determination section is positive, the second information processing apparatus permits uploading of the first data with respect to the service.

(Supplementary Note 14)

The information processing system according to supplementary note 12, in which: the second information processing apparatus causes a display mode of the first data in a case in which the determination result by the determination section is positive to be different from a display mode of the first data in a case in which the determination result by the determination section is negative or no determination result is obtained by the determination section.

(Supplementary Note 15)

An information processing method including: acquiring, by an information processing apparatus, information indicative of first data and information indicative of a user of the first data, the first data being virtual space data that is related to a service on a virtual space; retrieving, by the information processing apparatus, second data which is virtual space data identical with or similar to the first data; acquiring, by the information processing apparatus, information indicative of a purchaser of the second data; and determining, by the information processing apparatus, whether or not the purchaser of the second data is associated with the user of the first data.

(Supplementary Note 16)

A program for causing a computer to function as an information processing apparatus, the program causing the computer to function as: a first acquisition section that acquires information indicative of first data and information indicative of a user of the first data, the first data being virtual space data that is related to a service on a virtual space; a retrieval section that retrieves second data which is virtual space data identical with or similar to the first data; a second acquisition section that acquires information indicative of a purchaser of the second data; and a determination section that determines whether or not the purchaser of the second data is associated with the user of the first data.

(Supplementary Note 17)

An information processing apparatus including at least one processor, the at least one processor carrying out: a first acquisition process of acquiring information indicative of first data and information indicative of a user of the first data, the first data being virtual space data that is related to a service on a virtual space; a retrieval process of retrieving second data which is virtual space data identical with or similar to the first data; a second acquisition process of acquiring information indicative of a purchaser of the second data; and a determination process of determining whether or not the purchaser of the second data is associated with the user of the first data.

Note that the information processing apparatus can further include a memory. The memory can store a program for causing the processor to carry out the first acquisition process, the retrieval process, the second acquisition process, and the determination process. The program can be stored in a computer-readable non-transitory tangible storage medium.

### REFERENCE SIGNS LIST

1, 1A, 1B, 2A, 3A, 3B: Information processing apparatus
10, 10B, 20, 30: Control unit
11: First acquisition unit
12: Retrieval unit
13: Second acquisition unit
14: Determination unit
15: Determination result provision unit
16: Third acquisition unit
21: Service provision unit
100A, 100B: Information processing system

1. An information processing apparatus comprising at least one processor, the at least one processor carrying out:
a first acquisition process of acquiring information indicative of first data and information indicative of a user of the first data, the first data being virtual space data that is related to a service on a virtual space;
a retrieval process of retrieving second data which is virtual space data identical with or similar to the first data;
a second acquisition process of acquiring information indicative of a purchaser of the second data; and
a determination process of determining whether or not the purchaser of the second data is associated with the user of the first data.

2. The information processing apparatus according to claim 1, wherein:
the second data which is retrieved by the at least one processor in the retrieval process includes data that is different from the first data in terms of at least any of a color, a texture, and a partial shape in the virtual space.

3. The information processing apparatus according to claim 1, wherein:
the at least one processor further carries out a third acquisition process of acquiring, from a preparer of the second data, identification information indicative of the preparer and license information for the second data; and
the at least one processor determines, in the determination process, whether or not the purchaser of the second data is associated with the user of the first data with reference to the license information.

4. The information processing apparatus according to claim 3, wherein:
the at least one processor retrieves the second data with reference to the license information in the retrieval process.

5. The information processing apparatus according to claim 3, wherein:
the license information includes information pertaining to an index indicating a degree of similarity between the first data and the second data; and
the at least one processor retrieves the second data with reference to the index in the retrieval process.

6. The information processing apparatus according to claim 1, wherein:
the at least one processor further carries out a service provision process of providing the service on the virtual space; and
the information indicative of the first data and the information indicative of the user of the first data which are acquired in the first acquisition process are each provided in the service provision process in response to an attempt by the user to upload the first data with respect to the service provision process.

7. The information processing apparatus according to claim 6, wherein:
a determination result in the determination process is provided in the service provision process.

8. The information processing apparatus according to claim 7, wherein:
in a case where the determination result in the determination process is positive, the at least one processor permits uploading of the first data with respect to the service in the service provision process.

9. The information processing apparatus according to claim 7, wherein:
in the service provision process, the at least one processor causes a display mode of the first data in a case in which the determination result in the determination process is positive to be different from a display mode of the first data in a case in which the determination result in the determination process is negative or no determination result is obtained in the determination process.

10. An information processing method, comprising:
acquiring, by at least one processor, information indicative of first data and information indicative of a user of the first data, the first data being virtual space data that is related to a service on a virtual space;
retrieving, by the at least one processor, second data which is virtual space data identical with or similar to the first data;
acquiring, by the at least one processor, information indicative of a purchaser of the second data; and
determining, by the at least one processor, whether or not the purchaser of the second data is associated with the user of the first data.

11. A computer-readable non-transitory storage medium storing a program for causing a computer to function as an information processing apparatus,
the program causing the computer to carry out:
a first acquisition process of acquiring information indicative of first data and information indicative of a user of the first data, the first data being virtual space data that is related to a service on a virtual space;
a retrieval process of retrieving second data which is virtual space data identical with or similar to the first data;
a second acquisition process of acquiring information indicative of a purchaser of the second data; and
a determination process of determining whether or not the purchaser of the second data is associated with the user of the first data.
